(19) United States
(12) Patent Application Publication
(10) Pub. No.: US 2006/0212319 A1
(43) Pub. Date: Sep. 21, 2006

(54) Device, system, method, and computer program product for providing customized travel information

(75) Inventors: Russell L. Strothmann, Broken Arrow, OK (US); Gary J. Potter, Denton, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sabre Inc., Southlake, TX (US)

(21) Appl. No.: 11/082,749

(22) Filed: Mar. 17, 2005

(51) Int. Cl. G06Q 10/00

(52) U.S. Cl. 705/5

(57) ABSTRACT

A device, system, method, and computer program product enable a traveler to generate customized travel information corresponding to a travel profile, and download the customized travel information to a portable data storage device for ease of viewing the information while traveling. A portable data storage device comprises an interface element and a data storage element. The interface element may be capable of interfacing with a travel information data provider to receive customized travel information, and capable of interfacing with a display device. The data storage element may be capable of storing the customized travel information received from the travel information data provider, and capable of storing an executable computer program. The interface element receives customized travel information from the travel information data provider in response to a traveler providing a travel profile. The executable computer program is executable by the display device for causing the display device to display the customized travel information.

### FIELD OF THE INVENTION

The present invention relates generally to travel planning systems, and more particularly, to devices, systems, methods, and computer program products for providing travel planning capability on a mobile device.

### BACKGROUND OF THE INVENTION

Planning a trip, whether for personal enjoyment or business purposes, can be a time-consuming and difficult task. Proper planning can ensure an enjoyable vacation, or a successful business trip. Accurate and adequate information is one of the keys to planning a trip. The traveler may need information to be able to get from the origin to the destination, such as flight schedules, road maps, and/or rail schedules. Additionally, the traveler may need information regarding accommodations available at the destination, such as hotels, campgrounds, hostels, or other lodging. The traveler may also require information about activities and attractions available at the destination, particularly if the trip is a vacation. These activities may include restaurants, museums, municipal parks, theme parks, sporting events, cultural events, and historic attractions.

Unfortunately, it can be difficult to obtain the necessary information when and where it is needed. The traveler may require such information while planning the trip, and the traveler may also require the information and/or updates to the information during the trip. It is also possible to obtain too much information, such that it is difficult to sort through the extraneous information to locate the useful information.

There are many sources of travel information available to those planning a trip. Tour books or guide books are widely available for many cities, states, regions, and/or countries. There are many drawbacks to using tour books, however. Tour books can be expensive, particularly if the traveler will be traversing several states or countries and therefore requires several different tour books. The need for several tour books could cost the traveler a significant amount of money. Tour books are also bulky and therefore difficult to travel with, particularly if several books are needed for a trip. It can be difficult and time consuming to search through a tour book to find useful information relating to accommodations, activities, and attractions appropriate for the traveler, as the tour book may contain a great deal of information regarding such accommodations, activities, and attractions that may not be of interest to the traveler. Tour books can quickly become out of date, causing the traveler to waste time considering accommodations, activities, and attractions that are no longer available, or requiring the traveler to spend even more money to replace an outdated tour book that the traveler previously purchased.

Travel planning websites and/or tourism websites, such as those maintained by local tourism boards, are used extensively for planning trips. Additionally, websites of individual accommodation, activity, or attraction vendors may be used to obtain travel planning information. Vast amounts of information are available on such websites. As with tour books, however, there are drawbacks to using such websites for travel planning. The large amount of information available may make it difficult to search through the inappropriate information and extract the useful information. The information typically cannot be accessed while traveling unless the traveler has a mobile wireless device with internet access. Even when the traveler has access to the internet using a mobile wireless device, it may be difficult to access the required information. If the traveler is using a laptop computer with wireless internet access, the traveler may not have access to a wireless network at every location along the trip. If the traveler is using a mobile telecommunication device with internet access, such as a cell phone, the traveler may again not have access to the necessary communication network to be able to access the internet at every location. Obtaining information using a mobile telecommunication device with internet access can be slow due to network limitations.

The known sources of travel planning information typically do not facilitate ease of use both during planning of a trip and while traveling. The known sources also may be difficult to search for useful information as these sources contain much information that may not be useful to a particular traveler. As such, there is a need for a device, system, method and computer program product for improving travel planning by providing a customized subset of information in a portable data storage device, thereby allowing a traveler to easily locate useful information while at any location.

### BRIEF SUMMARY OF THE INVENTION

A device, system, method and computer program product are therefore provided that enable a traveler to generate customized travel information corresponding to a travel profile, and download the customized travel information to a portable data storage device for ease of viewing the information while traveling.

In one embodiment, a system is provided that includes a travel information data provider, a portable data storage device for interfacing with the travel information data provider, and a display device responsive to the portable data storage device for displaying customized travel information. The portable data storage device may comprise an interface element and a data storage element. The interface element may be capable of interfacing with a local device to receive customized travel information from the travel information data provider in response to a traveler providing a travel profile, and may further be capable of interfacing with the display device. The data storage element may be capable of storing the customized travel information received from the travel information data provider, and may further be capable of storing an executable computer program that is executable by the display device and may cause the display device to display the customized travel information.

The travel profile typically comprises at least one of a departure date, a departure time, an origin location, an arrival date, an arrival time, a destination location, a mode of travel, a route of travel, an age of the traveler, a travel companion, an age of the travel companion, a lodging preference, a food preference, an activity preference, a payment method, or a budget. The customized travel information typically comprises at least one of an accommodation that is located less than a predefined distance from the route of travel or the destination location and that matches the lodging preference, a restaurant that is located less than a predefined distance from the route of travel or the destination location and that matches the food preference, an activity that is located less than a predefined distance from the route of travel or the destination location and that matches the activity preference and matches the age of the traveler and the age of the travel companion, driving directions from at least one location along the route of travel to at least one accommodation, restaurant or activity that is located less than a predefined distance from the route of travel, or an airline flight schedule for at least one flight that matches at least one of the departure date, the departure time, the origin location, the arrival date, the arrival time, or the destination location.

The portable data storage device may cause the display device to display at least one search field, may cause the data storage element to retrieve travel information matching at least one search criteria entered into the at least one search field by the traveler, and may cause the display device to display the travel information that matches the at least one search criteria.

The portable data storage device and, in particular, the executable computer program may cause the data storage element to retrieve travel information optimized for at least one of activity preference, budget, free time, availability of activity, or popularity of activity, and may cause the display device to display the optimized travel information.

The portable data storage device may cause the display device to prompt the traveler to enter a password, may compare the entered password to a password stored in the data storage element and associated with the traveler, and may cause the display device to display the customized travel information if the entered password matches the stored password.

The portable data storage device may compare an elapsed time since the customized travel information was received to a predefined time limit, and may cause the display device to display the customized travel information if the elapsed time is less than the predefined time limit.

The portable data storage device and, in particular, the executable computer program may cause the interface element to interface with the travel information data provider to create a reservation for at least one accommodation, restaurant, or activity in response to a selection by the traveler.

The portable data storage device may cause the display device to display contact information for at least one accommodation, restaurant, or activity to enable the traveler to create a reservation, wherein the contact information comprises at least one of a centralized call center telephone number, a centralized call center website, a telephone number for the accommodation, restaurant, or activity, or a website for the accommodation, restaurant, or activity.

The portable data storage device may cause the display device to interface with a travel planning website over a wireless network to create a reservation for at least one accommodation, restaurant, or activity in response to a selection by the traveler.

In addition to the portable data storage device and the system for providing customized travel information as described above, other aspects of the present invention are directed to corresponding methods and computer program products for providing customized travel information.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a portable data storage device, according to one embodiment of the present invention;

FIG. 2 is a schematic block diagram of a system for providing customized travel information, according to one embodiment of the present invention; and

FIG. 3 is a flowchart of the operation of providing customized travel information, according to one embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

FIG. 1 is a perspective view of a portable data storage device, according to one embodiment of the present invention. Portable data storage device 100 comprises a device body 102 and an interface connector 104. Device body 100 would typically house non-volatile memory, such as flash memory, for storing data and/or executable computer programs. In one embodiment of the invention, portable data storage device 100 is a USB (universal serial bus) memory stick. A USB memory stick may also be termed a key drive, a pen drive, or a pocket drive. A USB memory stick may be inserted into a USB port of a computer or other microprocessor based device such that data and/or executable computer programs on the computer or other device may be transferred to and stored on the USB memory stick. The USB memory stick may then be removed and transported to another location where it may be inserted into or otherwise operably connected to a second computer or microprocessor based device. The data may then be read by the second computer or other device, the data may be transferred from the USB memory stick onto the second computer or other device, or the second computer or other device may execute the executable computer program stored on the USB memory stick. While the portable data storage device of the present invention will be described in terms of a USB memory stick, it should be appreciated that the present invention may be used with any portable data storage device capable of storing data and executable computer programs, such as a portable hard drive.

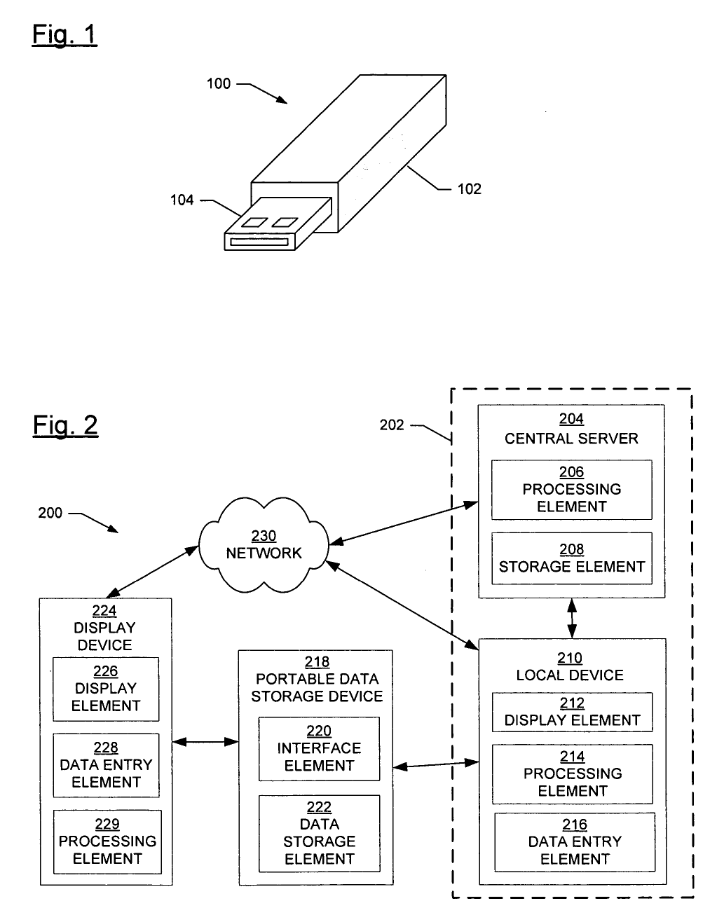

FIG. 2 is a schematic block diagram of a system for providing customized travel information, according to one embodiment of the present invention. The system 200 comprises a travel information data provider 202, a portable data storage device 218, and a display device 224. The travel information data provider 202 comprises a central server 204 and a local device 210. The central server 204 comprises a processing element 206 and a storage element 208. The local device 210 comprises a display element 212, a processing element 214, and a data entry element 216. Local device 210 may be in communication with central server 204 via network 230, which may be the internet or any other suitable network, or via a dedicated communication line. Portable data storage device 218 comprises interface element 220 and data storage element 222. Display device 224 comprises display element 226, data entry element 228, and processing element 229.

In an exemplary embodiment, local device 210 may be a kiosk in a convenient location for access by a traveler. For example, such a kiosk may be located at an airport, a car rental office, a train station, a gas station, a shopping mall, or a travel agency. A traveler desiring customized travel information regarding an upcoming trip may locate and use such a local device. The processing element 214 of the local device 210 would typically cause the display element 212 to prompt the traveler to enter a travel profile by using the data entry element 216 to answer a series of questions. The data entry element 216 may comprise a touch-screen, a QWERTY keyboard, or any suitable data entry device as is known in the art.

Upon prompting by the local device 210, the traveler may enter information regarding the traveler's upcoming trip, with such information comprising the travel profile. Such information may include, but is not limited to, the traveler's planned departure date and time, where the traveler will be departing from, the planned arrival date and time, the destination location, the length of stay at the destination location, the mode of travel (e.g., car, airplane, train), the planned route of travel, the age of the traveler, any travel companions who will be accompanying the traveler, the age(s) of the travel companion(s), any lodging preferences (e.g., budget hotel, luxury hotel, or bed and breakfast), any food preference (e.g., fast food or sit-down meal), any activity preference (e.g., sporting activities, cultural activities), the traveler's preferred payment method (e.g., credit card type and number), and the traveler's daily and/or total trip budget. The travel profile would then typically be transmitted by the local device to the central server 204. The communication between the local device and the central server would typically be encrypted to protect the traveler's personal information.

The storage element 208 of the central server would typically contain one or more extensive databases of travel information. This travel information would typically include locations, rates, and other information related to accommodations, dining, activities, and attractions. For example, the storage element 208 may contain the names, locations, rates, and availability for hotels, motels, inns, campgrounds, and recreational vehicle parks. The storage element may contain the names, locations, and price ranges for restaurants. The storage element may contain information on activities and attractions, such as museums, municipal parks, theme parks, sporting events, cultural events, and historic attractions. It should be appreciated that this travel information may be stored in a single database or multiple databases in central server 204. Alternatively, the travel information may be located in several databases located in several different servers, with the central server 204 in communication with these different servers and obtaining the travel information as needed.

The processing element 206 of central server 204 would then typically compare the travel profile received from the local device 210 to the complete set of travel information in storage element 208. The processing element 206 would identify the travel information that would be of interest to the traveler for the specific trip described in the travel profile, and the processing element would generate customized travel information corresponding to the travel profile. For example, the customized travel information may include information about accommodations, such as hotels and inns, that are located within a predefined distance (e.g., five miles) of the route of travel or the destination location and that match the traveler's lodging preference. Additionally, the customized travel information may include information about restaurants that are located within a predefined distance of the route of travel or the destination location and that match the traveler's food preference. The customized travel information may include information about activities that are located within a predefined distance of the route of travel or the destination location, that match the traveler's activity preference, and that suit the age of the traveler and the age(s) of the travel companion(s). The customized travel information may include driving directions from at least one location along the route of travel to at least one accommodation, restaurant or activity that is located within a predefined distance of the route of travel. The customized travel information may include airline flight schedules for flights that match the departure date, the departure time, the origin location, the arrival date, the arrival time, or the destination location. Such customized information is more likely to be useful to the traveler than the complete set of travel information available because the customized information has been matched to the traveler's preferences and the specifics of the trip. The customized information will also typically be easier to search because the customized information is a much smaller subset of the complete travel information available. The customized travel information would then typically be transmitted by the central server 204 to the local device 210.

In an alternative embodiment, the local device 210 may be a computer belonging to or otherwise utilized by the traveler and communicating with the central server via the internet. In another alternative embodiment, the local device and the central server may be combined in a single device, such that the complete set of travel information is stored at the local device, thereby speeding the generation of the customized travel information because there would be no communication with a remote device.

After the customized travel information has been transmitted to the local device 210, the traveler would then typically be prompted to insert a portable data storage device 218 into the local device 210, if the portable data storage device is not already inserted. As discussed above, the portable data storage device may be a USB memory stick, and would therefore be inserted into a USB port in the local device 210. If a different type of portable data storage device is capable of being used instead of or in addition to the USB memory stick, then the local device 210 would have one or more ports corresponding to the different types of portable data storage devices capable of being used. The traveler may use a personal data storage device that the traveler already possesses. Alternatively, if the local device 210 is located in a commercial establishment, the commercial establishment may sell the personal data storage device. If the local device is a kiosk, then the kiosk may dispense the personal data storage device.

When the portable data storage device 218 is inserted into the local device 210, the interface element 220 of the portable data storage device 218 would enable communication between the local device and the portable data storage device. The processing element 214 of the local device would cause the customized travel information to be downloaded to the portable data storage device 218. The customized travel information would be stored in the data storage element 222 of the portable data storage device 218. In addition to the customized travel information, an executable computer program would also typically be downloaded to the portable data storage device 218 and stored in the data storage element 222. The executable computer program enables the traveler to access the customized travel information using a display device, as discussed in detail below. In an alternative embodiment, the portable data storage device 218 could be sold with the executable computer program already installed. In such an embodiment, the local device 210 would typically have the capability to download an update for the executable computer program to the portable data storage device.

Prior to downloading the customized travel information and the executable computer program to the portable data storage device 218, the traveler may be prompted to input a password to the local device 210. The processing element of the local device would then typically incorporate the password into the information downloaded to the portable data storage device, such that the password would need to be entered to view the information on the display device.

After the customized travel information and the executable computer program have been downloaded to the portable data storage device 218, the traveler may take the portable data storage device on the trip. The traveler would typically use a display device 224 to view and search the customized travel information residing on the portable data storage device. The display device 224 may be any device capable of interfacing with the portable data storage device, executing the executable computer program, and displaying the customized travel information. For example, the display device may be a media player, a personal digital assistant (PDA), or a cell phone. Additionally, the portable data storage device and the display device may be combined in one device.

The display device 224 will typically comprise a display element 226, a data entry element 228, and a processing element 229. The data entry element may comprise a touch-screen, a QWERTY keyboard, an alphanumeric keypad, or any suitable data entry device as is known in the art. The portable data storage device 218 would typically be inserted into a USB port in the display device 224, or inserted into a different type of port if the portable data storage device is not a USB device. When the portable data storage device 218 is inserted into the display device 224, the processing element 229 would recognize that the portable data storage device has been inserted and would execute the executable computer program that is stored in data storage element 222. This executable computer program would typically cause a menu to be displayed on the display element 226 of the display device 224. Using the menu and the data entry element 228, the traveler could select customized travel information to view or could search the customized travel information. For example, the menu may comprise a list of actions the traveler can perform, such as viewing by category (e.g., accommodations, dining, activities, and attractions), viewing by location, searching by name, and searching by location. The traveler may select the desired action using the data entry element 228, such as by entering a number or letter corresponding with the desired action, or touching the screen adjacent to the displayed option.

Prior to displaying a menu or any of the customized travel information, the executable computer program, executing within the processing element 229, may cause the display element 226 to prompt the traveler to enter the traveler's predefined password. The entered password would be compared to the stored password, and the customized travel information would only be displayed if the entered password matches the stored password.

Prior to displaying a menu or any of the customized travel information, the executable computer program, executing within the processing element 229, may also compare the current date to a predefined expiration date, such that the customized travel information would only be displayed if a predefined amount of time has not passed. In one embodiment of the present invention, the traveler may pay a particular price for access to the customized travel information for a defined period of time (e.g., one month), and the traveler may pay another, higher price for access to the information for an unlimited period of time.

The traveler may search the customized travel information to identify information regarding a specific accommodation, restaurant, activity, or attraction. The traveler typically may search by category (e.g., accommodation, restaurant, activity, or attraction), by location, by price, by availability, by time, or by any combination of these search criteria. For example, the traveler may search for Mexican restaurants in a particular city that are open at midnight. The search criteria would be entered using the data entry element 228. The executable computer program, executing within the processing element 229, would use the search criteria to identify all entries within the customized travel data that meet the entered search criteria, and cause the display element 226 to display the identified entries.

When searching by location, there may be several ways that the executable computer program knows the location to use in the search. The traveler may enter a city or town name in a search field. The executable computer program, executing within the processing element 229, could then search for entries within the customized travel information located in that city or town. The executable computer program may also know what cities and/or towns are located within a predefined distance of the entered city or town, and thereby search for entries located in those nearby cities or town. Alternatively, the traveler may enter the highway number and mile marker of the traveler's current location. The portable data storage device may have information stored in the data storage element enabling the executable computer program to cross-reference highway and mile marker information to city or town, and thus enabling a search for entries located in such cities or towns. The executable computer program may obtain the traveler's current location from the processing element of the display device. For example, the display device may comprise a global positioning system (GPS) receiver, such that the display device can determine the traveler's current location and provide such information to the executable computer program. The display device may also comprise a wireless network transceiver, such that the display device can access an available wireless network and query the network to determine the traveler's current location and provide such information to the executable computer program.

Upon executing the executable computer program, the display device may provide a trip optimizing functionality to enable the traveler to optimize the number and type of activities in which the traveler participates during the trip. The executable computer program may interface with a scheduling application that is executing on the display device, such that the executable computer program knows what times the traveler is free to participate in activities. The display device may suggest activities that would fit into the traveler's free time. The display device may optimize activities based on the availability of such activities. For example, the display device may suggest attending the theatre on a particular night because that is the only night for which tickets are available. The display device may suggest visiting attractions on particular dates and at particular times because of the dates and times the attractions operate. The display device may optimize activities based on the traveler's daily or total budget by, for example, not suggesting activities whose costs exceed the traveler's daily budget. The display device may optimize activities based on the popularity of activities, attractions, and restaurants based on how many other travelers chose such activities, attractions, and restaurants.

Upon executing the executable computer program, the display device may allow the traveler to make reservations or purchase tickets for identified and selected accommodations, restaurants, activities, and attractions. There are many different methods by which the display device may provide this functionality. If the display device is capable of connecting to the internet, either via a wired or wireless network, the display device may connect to the central server 204 via the internet and transmit the request for reservations or tickets. The central server may be capable of securing the requested reservations or tickets, either directly, by interfacing with a travel planning website, such as Travelocity, or by interfacing with a Global Distribution System (GDS), such as Sabre. Alternatively, the display device may interface directly with a travel planning website to request the reservations or tickets. In another embodiment of the invention, the display device may be capable of connecting to a telephone network, such as a cellular network, or the display device may comprise a cellular telephone. In such an embodiment, the display device may transmit the request for reservations or tickets over the telephone network to the central server. The central server may then be capable of securing the requested reservations or tickets as discussed above. In another alternative embodiment, the traveler may select the desired reservations or tickets and store the selections in the memory of the portably data storage device, locate a local device 210, and insert the portable data storage device 218 into the local device 210. The local device would then retrieve the reservation or ticket request from the portable data storage device and transmit the request to the central server 204. The central server may then secure the requested reservations or tickets as discussed above. In another alternative embodiment, the customized travel information may include a unique reference number for each accommodation, restaurant, activity, and attraction. The traveler may then secure reservations or tickets by calling a predefined telephone number and accessing an interactive voice response (IVR) system. Similarly, the traveler may secure reservations or tickets by telephoning a call center and speaking with a customer service representative.

As discussed above, the display device 224 may be capable of accessing the internet, via a wired or wireless network. As the traveler's planned travel schedule is known by the central server 204, the central server may transmit marketing information, such as advertisements and discount coupons, for businesses located where the traveler is traveling. For example, a restaurant located in a particular city may request that a discount coupon that is valid for a particular day be transmitted to those travelers whose travel profiles indicate that the travelers will be in that particular city on that particular day.

It should be appreciated that the overall system architecture shown in FIG. 2 is for example purposes only, and not intended to limit the scope of the present invention. The system of the present invention could be implemented using a number of different system configurations.

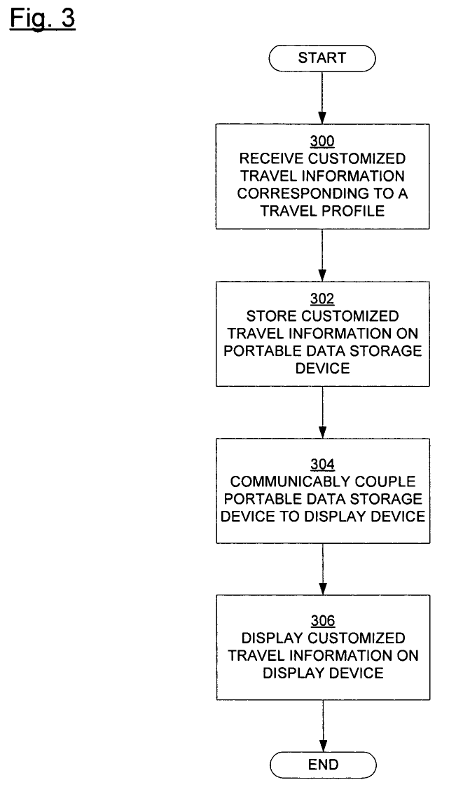

FIG. 3 is a flowchart of the operation of providing customized travel information, according to one embodiment of the present invention. As shown in block 300, customized travel information corresponding to a travel profile is received. The customized travel information is stored in a portable data storage device, as shown in block 302. The portable data storage device is communicably coupled to a display device, as shown in block 304. The customized travel information may then be displayed on a display device, as shown in block 306.

The method of providing customized travel information may be embodied by a computer program product. Likewise, the method of displaying the customized travel information on a display device and then interacting with the display device may be embodied by a computer program product. Each computer program product includes a computer-readable storage medium, such as the non-volatile storage medium, and computer-readable program code portions, such as a series of computer instructions, embodied in the computer-readable storage medium. In regards to the provision of customized travel information, the computer program is stored by a data storage device and executed by an associated processing unit, such as the processing element of the server. With regards to the display of the customized travel information by the display device and other interactions with the display device, the computer program product may be stored by the data storage element of the portable data storage device and executed by the processing element of the display device.

In this regard, FIG. 3 is a flowchart of methods and program products according to one aspect of the invention. It will be understood that each step of the flowchart, and combinations of steps in the flowchart, can be implemented by computer program instructions. These computer program instructions may be loaded onto one or more computers or other programmable apparatus to produce a machine, such that the instructions which execute on the computer or other programmable apparatus create means for implementing the functions specified in the flowchart step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart step(s).

Accordingly, steps of the flowchart support combinations of means for performing the specified functions, combinations of steps for performing the specified functions and program instruction means for performing the specified functions. It will also be understood that each step of the flowchart, and combinations of steps in the flowchart, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A portable data storage device for providing customized travel information, the portable data storage device comprising:
an interface element capable of interfacing with a local device to receive customized travel information from a travel information data provider in response to a traveler providing a travel profile, the interface element further capable of interfacing with a display device; and
a data storage element, the data storage element capable of storing the customized travel information received from the travel information data provider, the data storage element further capable of storing an executable computer program that is executable by the display device for causing the display device to display the customized travel information.

2. The portable data storage device of claim 1, wherein the travel profile comprises at least one of a departure date, a departure time, an origin location, an arrival date, an arrival time, a destination location, a mode of travel, a route of travel, an age of the traveler, a travel companion, an age of the travel companion, a lodging preference, a food preference, an activity preference, a payment method, or a budget; and wherein the customized travel information comprises at least one of an accommodation that is located less than a predefined distance from the route of travel or the destination location and that matches the lodging preference, a restaurant that is located less than a predefined distance from the route of travel or the destination location and that matches the food preference, an activity that is located less than a predefined distance from the route of travel or the destination location and that matches the activity preference and matches the age of the traveler and the age of the travel companion, driving directions from at least one location along the route of travel to at least one accommodation, restaurant or activity that is located less than a predefined distance from the route of travel, or an airline flight schedule for at least one flight that matches at least one of the departure date, the departure time, the origin location, the arrival date, the arrival time, or the destination location.

3. The portable data storage device of claim 1, wherein the executable computer program causes the display device to display at least one search field; wherein the executable computer program causes the data storage element to retrieve travel information matching at least one search criteria entered into the at least one search field by the traveler; and wherein the executable computer program causes the display device to display the travel information that matches the at least one search criteria.

4. The portable data storage device of claim 2, wherein the executable computer program causes the data storage element to retrieve travel information optimized for at least one of activity preference, budget, free time, availability of activity, or popularity of activity; and wherein the executable computer program causes the display device to display the optimized travel information.

5. The portable data storage device of claim 1, wherein the executable computer program causes the display device to prompt the traveler to enter a password, and wherein the executable computer program compares the entered password to a password stored in the data storage element and associated with the traveler, and wherein the executable computer program causes the display device to display the customized travel information if the entered password matches the stored password.

6. The portable data storage device of claim 1, wherein the executable computer program compares an elapsed time since the customized travel information was received to a predefined time limit, and wherein the executable computer program causes the display device to display the customized travel information if the elapsed time is less than the predefined time limit.

7. The portable data storage device of claim 2, wherein the executable computer program causes the interface element to interface with the travel information data provider to create a reservation for at least one accommodation, restaurant, or activity in response to a selection by the traveler.

8. The portable data storage device of claim 2, wherein the executable computer program causes the display device to display contact information for at least one accommodation, restaurant, or activity to enable the traveler to create a reservation, wherein the contact information comprises at least one of a centralized call center telephone number, a centralized call center website, a telephone number for the accommodation, restaurant, or activity, or a website for the accommodation, restaurant, or activity.

9. The portable data storage device of claim 2, wherein the executable computer program causes the display device to interface with a travel planning website over a wireless network to create a reservation for at least one accommodation, restaurant, or activity in response to a selection by the traveler.

10. A system for providing customized travel information to a traveler, the system comprising:
a portable data storage device, the portable data storage device comprising an interface element capable of receiving customized travel information from a travel information data provider in response to a travel profile; the portable data storage device further comprising a data storage element, the data storage element capable of storing the customized travel information received from the travel information data provider, the data storage element further capable of storing an executable computer program; and
a display device, the display device comprising a display element and a data entry element, wherein the display device is capable of executing the executable computer program of the portable data storage device, and wherein the display device is capable of displaying the customized travel information.

11. The system of claim 10, further comprising:
a travel information data provider, the travel information data provider comprising a processing element and a storage element.

12. The system of claim 10, wherein the travel profile comprises at least one of a departure date, a departure time, an origin location, an arrival date, an arrival time, a destination location, a mode of travel, a route of travel, an age of the traveler, a travel companion, an age of the travel companion, a lodging preference, a food preference, an activity preference, a payment method, or a budget; and wherein the customized travel information comprises at least one of an accommodation that is located less than a predefined distance from the route of travel or the destination location and that matches the lodging preference, a restaurant that is located less than a predefined distance from the route of travel or the destination location and that matches the food preference, an activity that is located less than a predefined distance from the route of travel or the destination location and that matches the activity preference and matches the age of the traveler and the age of the travel companion, driving directions from at least one location along the route of travel to at least one accommodation, restaurant or activity that is located less than a predefined distance from the route of travel, or an airline flight schedule for at least one flight that matches at least one of the departure date, the departure time, the origin location, the arrival date, the arrival time, or the destination location.

13. The system of claim 10, wherein the executable computer program causes the display device to display at least one search field; wherein the executable computer program causes the data storage element of the portable data storage device to retrieve travel information matching at least one search criteria entered into the at least one search field by the traveler; and wherein the executable computer program causes the display device to display the travel information that matches the at least one search criteria.

14. The system of claim 11, wherein the executable computer program causes the data storage element of the portable data storage device to retrieve travel information optimized for at least one of activity preference, budget, free time, availability of activity, or popularity of activity; and wherein the executable computer program causes the display device to display the optimized travel information.

15. The system of claim 10, wherein the executable computer program causes the display device to prompt the traveler to enter a password, and wherein the executable computer program compares the entered password to a password stored in the data storage element and associated with the traveler, and wherein the executable computer program causes the display device to display the customized travel information if the entered password matches the stored password.

16. The system of claim 10, wherein the executable computer program compares an elapsed time since the customized travel information was received to a predefined time limit, and wherein the executable computer program causes the display device to display the customized travel information if the elapsed time is less than the predefined time limit.

17. The system of claim 11, wherein the executable computer program causes the portable data storage device to interface with the travel information data provider to create a reservation for at least one accommodation, restaurant, or activity in response by a selection by the traveler.

18. The system of claim 11, wherein the executable computer program causes the display device to display contact information for at least one accommodation, restaurant, or activity to enable the traveler to create a reservation, wherein the contact information comprises at least one of a centralized call center telephone number, a centralized call center website, a telephone number for the accommodation, restaurant, or activity, or a website for the accommodation, restaurant, or activity.

19. The system of claim 11, wherein the executable computer program causes the display device to interface with a travel planning website over a wireless network to create a reservation for at least one accommodation, restaurant, or activity in response by a selection by the traveler.

20. A method of providing customized travel information, the method comprising:
receiving customized travel information corresponding to a travel profile;
storing the customized travel information on a portable data storage device;
communicably coupling the portable data storage device to a display device; and
displaying with the display device the customized travel information that is stored on the portable data storage device.

21. The method of claim 20, wherein the travel profile comprises at least one of a departure date, a departure time, an origin location, an arrival date, an arrival time, a destination location, a mode of travel, a route of travel, an age of the traveler, a travel companion, an age of the travel companion, a lodging preference, a food preference, an activity preference, a payment method, or a budget; and wherein the customized travel information comprises at least one of an accommodation that is located less than a predefined distance from the route of travel or the destination location and that matches the lodging preference, a restaurant that is located less than a predefined distance from the route of travel or the destination location and that matches the food preference, an activity that is located less than a predefined distance from the route of travel or the destination location and that matches the activity preference and matches the age of the traveler and the age of the travel companion, driving directions from at least one location along the route of travel to at least one accommodation, restaurant or activity that is located less than a predefined distance from the route of travel, or an airline flight schedule for at least one flight that matches at least one of the departure date, the departure time, the origin location, the arrival date, the arrival time, or the destination location.

22. The method of claim 20, further comprising:
displaying at least one search field;
retrieving travel information matching at least one search criteria entered into the at least one search field by the traveler; and
displaying the travel information that matches the at least one search criteria.

23. The method of claim 21, further comprising:
retrieving travel information optimized for at least one of activity preference, budget, free time, availability of activity, or popularity of activity; and
displaying the optimized travel information.

24. The method of claim 20, further comprising:
prompting the traveler to enter a password;
comparing the entered password to a stored password that is associated with the traveler; and
displaying the customized travel information if the entered password matches the stored password.

25. The method of claim 20, further comprising:
comparing an elapsed time since the customized travel information was received to a predefined time limit; and
displaying the customized travel information if the elapsed time is less than the predefined time limit.

26. The method of claim 21, further comprising:
interfacing with the travel information data provider to create a reservation for at least one accommodation, restaurant, or activity in response by a selection by the traveler.

27. The method of claim 21, further comprising:
displaying contact information for at least one accommodation, restaurant, or activity to enable the traveler to create a reservation, wherein the contact information comprises at least one of a centralized call center telephone number, a centralized call center website, a telephone number for the accommodation, restaurant, or activity, or a website for the accommodation, restaurant, or activity.

28. The method of claim 21, further comprising:
interfacing with a travel planning website over a wireless network to create a reservation for at least one accommodation, restaurant, or activity in response by a selection by the traveler.

29. A computer program product for providing customized travel information, the computer program product comprising at least one computer-readable storage medium of a portable data storage device having computer-readable program code portions stored therein, the computer-readable program code portions comprising:
a first executable portion capable of receiving customized travel information corresponding to a travel profile;
a second executable portion capable of storing the customized travel information on the portable data storage device;
a third executable portion capable of establishing communication with a display device; and
a fourth executable portion capable of directing the display device to display the customized travel information.

30. The computer program product of claim 29, wherein the travel profile comprises at least one of a departure date, a departure time, an origin location, an arrival date, an arrival time, a destination location, a mode of travel, a route of travel, an age of the traveler, a travel companion, an age of the travel companion, a lodging preference, a food preference, an activity preference, a payment method, or a budget; and wherein the customized travel information comprises at least one of an accommodation that is located less than a predefined distance from the route of travel or the destination location and that matches the lodging preference, a restaurant that is located less than a predefined distance from the route of travel or the destination location and that matches the food preference, an activity that is located less than a predefined distance from the route of travel or the destination location and that matches the activity preference and matches the age of the traveler and the age of the travel companion, driving directions from at least one location along the route of travel to at least one accommodation, restaurant or activity that is located less than a predefined distance from the route of travel, or an airline flight schedule for at least one flight that matches at least one of the departure date, the departure time, the origin location, the arrival date, the arrival time, or the destination location.

31. The computer program product of claim 29, further comprising:
a fifth executable portion capable of displaying at least one search field;
a sixth executable portion capable of retrieving travel information matching at least one search criteria entered into the at least one search field by the traveler; and
a seventh executable portion capable of displaying the travel information that matches the at least one search criteria.

32. The computer program product of claim 30, further comprising:
a fifth executable portion capable of retrieving travel information optimized for at least one of activity preference, budget, free time, availability of activity, or popularity of activity; and
a sixth executable portion capable of displaying the optimized travel information.

33. The computer program product of claim 29, further comprising:
a fifth executable portion capable of prompting the traveler to enter a password;
a sixth executable portion capable of comparing the entered password to a stored password that is associated with the traveler; and
a seventh executable portion capable of displaying the customized travel information if the entered password matches the stored password.

34. The computer program product of claim 29, further comprising:
a fifth executable portion capable of comparing an elapsed time since the customized travel information was received to a predefined time limit; and
a sixth executable portion capable of displaying the customized travel information if the elapsed time is less than the predefined time limit.

35. The computer program product of claim 30, further comprising:
a fifth executable portion capable of interfacing with the travel information data provider to create a reservation for at least one accommodation, restaurant, or activity in response by a selection by the traveler.

36. The computer program product of claim 30, further comprising:
a fifth executable portion capable of displaying contact information for at least one accommodation, restaurant, or activity to enable the traveler to create a reservation, wherein the contact information comprises at least one of a centralized call center telephone number, a centralized call center website, a telephone number for the accommodation, restaurant, or activity, or a website for the accommodation, restaurant, or activity.

37. The computer program product of claim 30, further comprising:
a fifth executable portion capable of interfacing with a travel planning website over a wireless network to create a reservation for at least one accommodation, restaurant, or activity in response by a selection by the traveler.
